(19) United States
(12) Patent Application Publication
(10) Pub. No.: US 2014/0238620 A1
(43) Pub. Date: Aug. 28, 2014

(54) ROTARY EVAPORATOR

(71) Applicant: KNF Neuberger GmbH, Freiburg (DE)

(72) Inventors: Erwin Hauser, Emmendingen (DE); Erich Becker, Bad Krozingen (DE)

(73) Assignee: KNF Neuberger GmbH, Frieburg (DE)

(21) Appl. No.: 14/350,220

(22) PCT Filed: Sep. 25, 2012
(86) PCT No.: PCT/EP2012/004000

§ 371 Date: Apr. 7, 2014

(30) Foreign Application Priority Data
Oct. 8, 2011 (DE) 202011106544.1

(51) Int. Cl. B01D 1/22

(52) U.S. Cl. CPC B01D 1/228
USPC 159/11.1

(57) ABSTRACT

A rotary evaporator (1), to which a clamping insert (59) having a sleeve-like base shape is associated for clamping a vapor feed-through, in the form of a glass hollow shaft (8), in the hub (58) of a rotational drive (57). The clamping insert (2) includes clamping sections (K1, K2) which are spaced apart in the longitudinal direction and carry each at least one clamping slope (63, 64) which is beveled relative to the longitudinal axis of the clamping insert (59). The beveled clamping inclines interact with the associated counter inclines (65, 66) of the rotational drive (57) such that the clamping sections (K1, K2) are pressed against the glass hollow shaft (8) when axial pressure of the clamping insert (59) is applied. In one embodiment of the invention, the clamping insert (59) has supporting webs (60) which are oriented in the longitudinal direction thereof, the supporting webs being connected to each other via connecting webs (61, 62) which are oriented in a circumferential direction of the clamping insert (59). The connecting webs (61, 62) alternately connect to each other the web end regions of adjacent supporting webs (60), which are arranged either on the one or the other side of the clamping insert (59). The supporting webs (60) and the connecting webs (61, 62) are connected to form the sleeve-like base shape of the clamping insert (59) such that the spaced apart clamping sections (K1, K2) are formed by the connecting webs (61, 62) which are provided at the opposite ends of the clamping insert (59) and support the clamping inclines (63, 64). In another embodiment of the invention, the sealing ring (76) is designed as an annular disk, wherein the outer annular zone (78) of the annular disk is provided as a clamping edge, the annular disk has an inner annular zone (79) which is folded or angled in the longitudinal direction of the glass hollow shaft (8), and the sealing ring (76) bears sealingly against the glass hollow shaft (8) with a partial region (T) of the annular disk, this partial region being oriented in the longitudinal direction of the glass hollow shaft (8).

### BACKGROUND

The invention relates to a rotary evaporator, including a rotary drive with a hub and a clamping insert with a sleeve-like basic form for clamping a vapor feedthrough realized as a hollow glass shaft in the hub of the rotary drive, wherein the clamping insert comprises two clamping portions, which are spaced apart from one another in the longitudinal direction and carry in each case at least one clamping inclination beveled in relation to the longituidnal axis of the clamping insert, said clamping inclinations interacting with counter inclinations of the rotary drive associated therewith in such a manner that the clamping portions are pressed against the hollow glass shaft as a result of axial pressurization of the clamping insert, wherein the clamping insert has supporting webs which are oriented in the longitudinal direction thereof and are connected together by means of connecting webs which are oriented in the circumferential direction of the clamping insert and wherein the supporting webs and the connecting webs are connected in such a manner to form the sleeve-like basic form of the clamping insert.

Different designs of rotary evaporators are already known. Such rotary evaporators are intended for the gentle separation of liquid mixtures and solutions utilizing the variable boiling points of the components. Thus, rotary evaporators can also be utilized for drying, for solvent recovery and for similar processes. A heating bath in which a heated volume of water or oil is situated regularly serves as an evaporator element. An evaporator piston, which includes the solution to be evaporated in its piston interior, rotates in the heated water or volume of oil in the heating bath. Said solution is distributed on the heated inside walls of the piston of the rotating evaporator piston as a thin liquid film which can easily evaporate there. As a result of the rotation of the evaporator piston delay in boiling is also avoided and in conjunction with the heating bath a homogeneous temperature distribution is obtained in the medium to be evaporated. The additionally brought about thorough mixing of the heating bath facilitates the regulating of the effective heating temperature in a considerable manner. To avoid high temperatures which are linked to risks for the user and can also produce unwanted chemical reactions in the medium, the evaporating process is supported by an evacuating of the process chamber. The evaporator capacity is varied as a result of the temperature of the heating bath, the size of the piston and the speed of rotation of the evaporator piston as well as of the vacuum pressure set. On account of the general inertia of the temperatures of the medium and the process, the evaporation at constant temperatures is primarily controlled by the pressure. In order to be able to evacuate the process chamber, and in order to be able to connect the necessary coolant inflows and outflows to the required cooler, at least one hose connection, and regularly several hose connections which are connected to a vacuum pump or to a coolant inflow or outflow in each case by means of a flexible hose line, is provided on the glass assembly of the rotary evaporator which includes the evaporator piston.

Over the past decades, the usability, the safety and the automation of previously known rotary evaporators has been improved in a considerable manner. Occasionally, however, some disadvantages can be ascertained.

In order to allow the evaporator piston to rotate in the heating bath, said evaporator piston in the case of previously known rotary evaporators is connected by means of a ground-in connection to a hollow glass shaft which serves as the vapor feedthrough and is held in the hub of the rotary drive. For this purpose, a clamping insert, which is realized in the majority of cases as a clamping sleeve and transfers the rotary movement of the rotationally-drivable hub onto the hollow glass shaft, is slipped onto the hollow glass shaft. In order to be able to clamp the hollow glass shaft in the hub by means of the clamping insert, the clamping insert used in the case of the previously known rotary evaporators comprises two clamping portions which are spaced apart from one another in the longitudinal direction and carry in each case at least one clamping inclination which is beveled toward the longitudinal axis of the clamping insert. The clamping inclinations provided on the clamping portions of the clamping insert interact with counter inclinations of the rotary drive which are associated therewith in such a manner that the clamping portions are pressed against the hollow glass shaft as a result of axial pressurization of the clamping insert. Whilst the first shaft end of the hollow glass shaft which protrudes over the rotary drive is connected to the evaporator piston, the opposite second shaft end protrudes into a connecting opening which defines a connecting piece which leads to a cooler. In this case, a bearing ring seal, which abuts by way of an inner ring zone against the rotating hollow glass shaft and seals said hollow glass shaft in the transition region to the connecting piece of the cooler, is clamped on the drive housing of the rotary drive.

In the majority of cases the previously known clamping inserts comprise at least one sleeve portion which runs around in a ring-shaped manner and in its clear cross section has to correspond to the outside diameter of the hollow glass shaft. As the clear cross section of said clamping inserts at least in said sleeve portion which runs around in a ring-shaped manner therefore corresponds approximately to the outside diameter of the hollow glass shaft, the clamping insert of the previously known rotary evaporators can only be slipped onto the hollow glass shaft with effort. The sleeve portion which runs around in a ring-shaped manner can also make subsequent insertion of the hollow glass shaft into a clamping insert which is already situated in the rotary drive difficult or even impossible.

In the case of the previously known rotary evaporators, the bearing ring seals are only producible in the majority of cases with not inconsiderable expenditure. Said bearing ring seals are realized in design or shaping in a complex manner or are produced from different components or component parts. As said bearing ring seals are wear parts which have to be replaced at intervals, the costly production of the bearing ring seals is also crucial to the user as regards costs.

EP 2 213 353 A1 has already made known a rotary evaporator of the type mentioned in the introduction which includes a rotary drive with a hub and a clamping insert with a sleeve-like basic form for clamping a vapor feedthrough realized as a hollow glass shaft in the hub of the rotary drive. The clamping insert comprises two clamping portions which are spaced apart from one another in the longitudinal direction and carry in each case at least one clamping inclination which is beveled in relation to the longitudinal axis of the clamping insert, said clamping inclinations interacting with counter inclinations of the rotary drive associated therewith in such a manner that the clamping portions are pressed against the hollow glass shaft as a result of axial pressurization of the clamping insert. The clamping insert has supporting webs which are oriented in the longitudinal direction thereof and are connected together by means of connecting webs, which connecting webs are arranged in the region of a central ring zone of the clamping insert and are oriented in the circumferential direction of the clamping insert. On their web ends which point in opposite directions, the supporting webs carry the clamping inclinations which are spaced apart from one another.

The clamping insert previously known from EP 2 213 353 A1 can certainly be slipped easily onto the hollow glass shaft by means of the supporting webs which protrude in a finger-shaped manner in the longitudnal direction of the clamping insert. However, as soon as the connecting webs connecting the supporting webs together are also to be slipped onto the hollow glass shaft, it is difficult to advance the clamping insert further because the connecting webs and the adjoining regions of the supporting webs predefine a ring-shaped contour of a constant diameter. As the clamping inclinations are provided on the opposite web ends of the supporting webs, a clamping closure between the hollow glass shaft and the clamping insert is only possible in part regions of the circumference of the clamping insert, whilst in the region of the connecting webs no clamping closure whatsoever is provided between the clamping insert and the hollow glass shaft.

### SUMMARY

Consequently, the object consists in creating a rotary evaporator of the type mentioned in the introduction where the sliding of the clamping insert onto the hollow glass shaft is made considerably easier.

The solution according to the invention of said object consists in that the connecting webs alternately connect the web end regions of adjacent supporting webs which are arranged on the one or on the other side of the clamping insert, and that the clamping portions which are spaced apart from one another are formed by the connecting webs which are provided on the opposite ends of the clamping insert and carry the clamping inclinations.

The clamping insert used in the case of the rotary evaporator according to the invention comprises supporting webs which are oriented in the longitudinal direction thereof. The supporting webs of the clamping insert are connected together by means of connecting webs which are oriented in the circumferential direction of the clamping insert. In this case, the connecting webs alternately connect the web end regions of adjacent supporting webs which are arranged on the one or on the other side of the clamping insert in such a manner that each supporting web is connected to its one adjacent supporting web by means of a connecting web which is arranged on the one side of the clamping insert and projects into the one circumferential direction, whilst it is connected to the other adjacent supporting web by means of a connecting web which is placed on the other side of the clamping insert and projects into the opposite circumferential direction. As the clamping insert has a loop-shaped or meander-shaped outer contour as a result of the supporting webs and of the connecting webs provided alternately on the opposite end regions of the supporting webs, and as said outer contour of the clamping insert, where required, can be widened in circumference in a simple manner, the clamping insert is able to be positioned comfortably on the hollow glass shaft. In this case, the connecting webs provided on the opposite ends of the clamping insert form clamping portions which are spaced apart from one another in the longitudinal direction, the connecting webs forming the clamping portions tapering toward the free ends of the clamping insert in such a manner that the clamping portions in each case carry at least one clamping incline, which is beveled in relation to the longitudinal axis of the clamping insert, and interact with counter inclines of the rotary drive associated therewith in such a manner that the clamping portions are pressed against the hollow glass shaft as a result of the axial pressurization of the clamping insert.

The clamping inclines of the clamping insert can taper in said same longitudinal direction of the clamping inert. A preferred embodiment, however, provides that the clamping inclines carried by the connecting webs provided on opposite ends of the clamping insert have in each case an outer cross section which tapers to the adjacent end of the clamping insert and consequently are tapered in opposite longitudinal directions pointing outward.

In order to be able to pressurize the clamping insert in the longitudinal direction in such a manner that the clamping portions abut against the hollow glass shaft in a frictionally engaged manner, it is advantageous when the clamping insert is insertable from the side of the hub which faces an evaporation vessel into said hub as far as up to a ring shoulder which is realized as a counter incline and when a clamping screw ring can preferably be releasably screwed onto the hub for the axial pressurization of the clamping insert and said clamping screw ring acts upon the clamping portion of the clamping insert which protrudes over the hub with a counter incline which is provided on the inside circumference of the clamping screw ring.

The hollow glass shaft is regularly connected to the evaporation vessel by means of a clamping or ground-in connection. This ground-in connection can sometimes only be released again with difficulty. A preferred embodiment according to the invention consequently provides that the clamping screw ring carries a thread which interacts with a counter thread on a forcing screw ring and that when the forcing screw ring is unscrewed from the clamping screw ring, the forcing screw ring acts upon an evaporation vessel in such a manner that a clamping or ground-in connection between said evaporation vessel and the hollow glass shaft which carries the evaporation vessel is releasable.

In order to establish the relative position of the hollow glass shaft and of the clamping insert slipped thereon, it must be established if the hollow glass shaft carries on its outside circumference at least one indentation or elevation with which is associated an elevation or indentation on the inside circumference of the clamping insert.

The elevation can be realized as a protruding journal which, in the established relative position, engages in an indentation which is developed as a complementary hole. As the clamping insert and preferably also the hollow glass shaft are realized in the majority of cases in a rotationally symmetrical manner, and as the relative position of the clamping insert and of the hollow glass shaft in the majority of cases only has to be established in the longitudinal direction, but not also in the circumferential direction, it is advantageous when at least one indentation provided on the hollow glass shaft or on the clamping insert is realized as an annular groove and the associated elevation is realized as an annular bead.

The hollow glass shaft can still also be subsequently pushed into a clamping insert situated in the hub of the rotary drive or pulled out of the same when the at least one indentation or elevation provided on the clamping insert is arranged in the part region of the clamping insert which protrudes over the hub and in particular on the inside circumference of the clamping portion which protrudes over the hub.

According to a particularly advantageous further development according to the invention, it is provided that the vapor feed-through which is realized as a hollow glass shaft caries an evaporation vessel on its one first shaft end and protrudes by way of its other second shaft end into a connecting opening of a cooler which is defined by a connecting piece, wherein a sealing ring abuts against the hollow glass shaft in a sealing manner, said sealing ring being clamped between the connecting piece and the drive housing and being realized as an annular disk, the outer ring zone of which is provided as a clamping edge, wherein the annular disk has an inner ring zone which is bent over or angled in the longitudinal direction of the hollow glass shaft, and wherein the sealing ring abuts sealingly in an elastic manner against the hollow glass shaft by way of a part region of the annular disk which is oriented in the longitudinal direction of the hollow glass shaft.

The sealing ring provided in the rotary evaporator according to the invention is developed as an annular disk, the outer ring zone of which serves as a clamping edge, by way of which the annular disk is able to be clamped between the connecting piece which leads to the cooler and the drive housing of the rotary housing. The annular disk has an inner ring zone which is bent over or angled in the longitudinal direction of the hollow glass shaft such that the sealing ring is able to abut against the hollow glass shaft in an elastic manner by way of a part region of the annular disk which is oriented in the longitudinal direction of the hollow glass shaft. The sealing ring of said bearing ring seal which is used in the rotary evaporator according to the invention is distinguished consequently by a simple design and simple shaping, as a result of which the expenditure linked to the production of said sealing ring which is required as a wear part can be kept low. As the inside ring zone abuts sealingly against the hollow glass shaft in a pre-stressed manner at least by way of a ring-shaped part region, in practice wear of the sealing ring caused by friction in the region of the ring zone is automatically compensated.

So that the bearing ring seal is able to seal the region between the connecting piece which leads to the cooler and the hollow glass shaft in a secure and permanent manner, it is expedient when at least one annular groove or one annular bead is provided at the connecting piece and/or at the drive housing and when the at least one annular groove and/or the at least one annular bead preferably has associated therewith a complementary annular groove or an annular bead on the clamping edge of the sealing ring. An associated and complementarily realized annular bead or an annular groove on the clamping edge of the sealing ring is not forcibly necessary, but is advantageous in order to secure the desired position of the clamping ring between the connecting piece and the drive housing.

The low expenditure on production is furthered more when the sealing ring is realized in one piece.

A preferred embodiment according to the invention provides that sealing ring is produced as a material compound and in particular as a Teflon compound. In particular, a sealing ring produced as a Teflon compound is distinguished by a low coefficient of friction and by reduced wear, which can also make long maintenance intervals possible.

The good sealing function also in the region of the clamping edge clamped between the connecting piece and the drive housing is furthered when at the connecting piece and/or at the drive housing and/or comprises at least one annular groove, with which a complementary annular groove or a complementary annular bead on the connecting piece and/or on the drive housing is associated.

A particularly simple shaping provides that the sealing ring is realized in an approximately U-shaped, L-shaped or j-shaped manner in longitudinal section.

In this case, the sealing ring comprises a shaping which is approximately j-shaped or in particular U-shaped in longitudinal section when the inside edge region and the edge region defining the annular opening of the sealing ring is curved or angled in a direction facing away from the hollow glass shaft.

### BRIEF DESCRIPTION OF THE DRAWINGS

Further features of the invention are provided in the following description of an exemplary embodiment according to the invention in conjunction with the claims and the drawing. The individual features can each be realized individually on their own or several together in the case of an embodiment according to the invention.

In the drawings:

FIG. 1 shows a perspective overall representation of a rotary evaporator which has a device stand from which a guide tower projects, wherein on the side of the guide tower a cradle which serves as a holder is movable, said cradle carrying a glass assembly with an evaporation vessel which can be immersed into a tempering vessel, and wherein the evaporation vessel has associated therewith a rotary drive which allows the evaporation vessel to rotate about its longitudinal axis in the tempering vessel,

FIG. 2 shows a perspective cross sectional representation of the guide tower of the rotary evaporator shown in FIG. 1,

FIG. 3 shows a schematized component part representation of the lifting drive which is arranged in the guide tower and is intended for moving the cradle which serves as a holder on the guide tower,

FIG. 4 shows a longitudinal section of the cradle which is movable on the guide tower and which carries the glass assembly, wherein a rotary drive which is pivotable about a horizontal pivot axis is provided on the cradle, by means of which rotary drive the evaporation vessel of the glass assembly is rotatable in the tempering vessel of the rotary evaporator,

FIG. 5 shows a perspective view of a detail of the guide tower from FIGS. 2 to 4 in the region of the cradle, wherein a graduation can be seen on the guide tower for indicating the lift height and a graduation can be seen on the cradle for indicating the pivot angle chosen for the rotary drive,

FIG. 6 shows a longitudinal section of the rotary drive from FIG. 4, wherein the rotary drive has a rotationally-drivable hub which penetrates a vapor feed-through which is realized as a hollow glass shaft, wherein the hollow glass shaft carries the evaporation vessel at its one shaft end and opens out into a connecting piece which leads to a cooler with its other shaft end, and wherein the rotary movement of the rotationally-drivable hub of the rotary drive is transmitted to the hollow glass shaft by means of a sleeve-shaped clamping insert which is slipped onto the hollow glass shaft,

FIG. 7 shows a longitudinal section of a detail of the rotary drive from FIGS. 4 and 6 in the region of the clamping insert slipped onto the hollow glass shaft,

FIG. 8 shows a perspective representation of the clamping insert from FIGS. 6 and 7,

FIG. 9 shows the hollow glass shaft, which penetrates the hub of the rotary drive, in the region of a sealing ring which serves as a bearing ring seal, which sealing ring is clamped by way of an outer clamping edge between the cooler-side connecting piece and a drive housing of the rotary drive and abuts against the rotating hollow glass shaft by way of an inside ring zone,

FIG. 10 shows a perspective representation of the sealing ring from FIG. 9, and

FIG. 11 shows a representation of a detail of the rotary evaporator from FIG. 1 in the region of its control elements realized as a remote control unit.

### DETAILED DESCRIPTION OF THE PREFERRED EMBODIMENTS

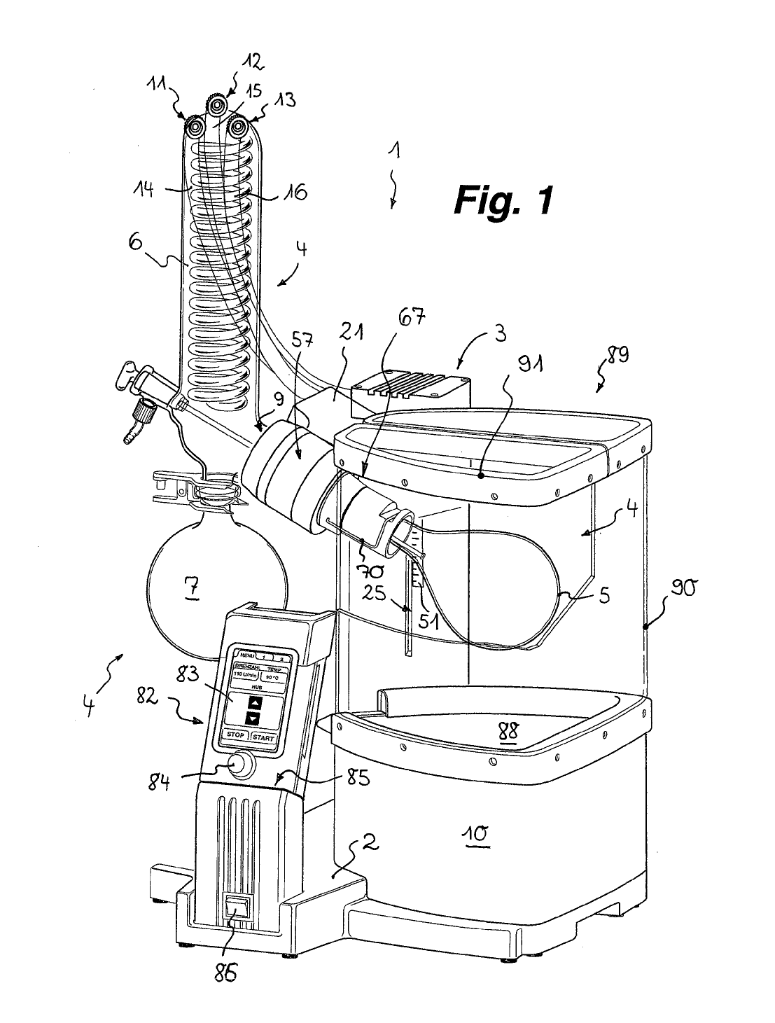

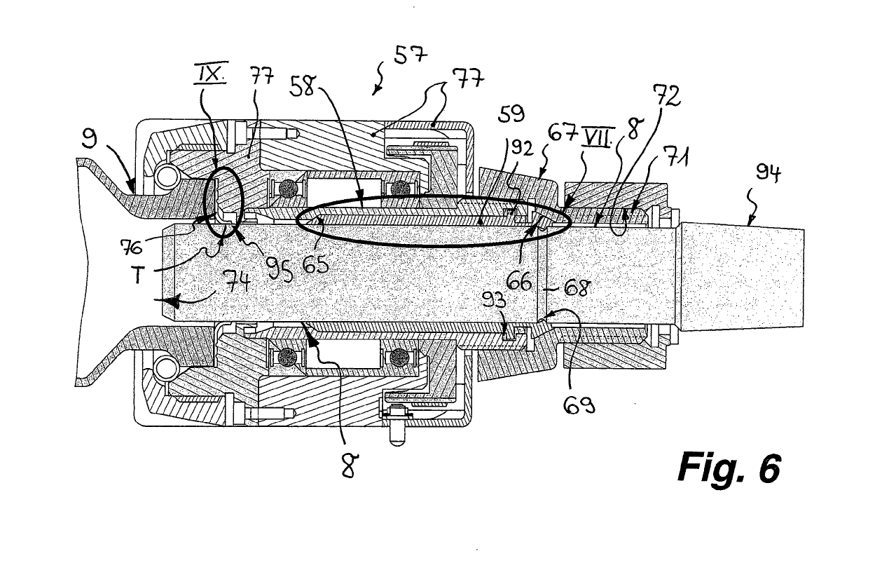

FIG. 1 shows a perspective view of a rotary evaporator 1. The rotary evaporator 1 has a device stand 2 which carries the structure of the rotary evaporator. A guide tower 3, which has a vertically oriented longitudinal axis, protrudes from the device stand 2. The rotary evaporator 1 has a glass assembly 4 which includes an evaporation vessel 5 which is realized here as an evaporator piston, a cooler 6 and a collecting vessel 7 which is detachably connected to the cooler 6. In this case, the evaporation vessel 5 is held by a hollow glass shaft 8 which serves as a vapor feed-through, is shown in more detail in FIGS. 6, 7 and 9 and opens out at its shaft end which is remote from the evaporation vessel 5 in a connecting piece 9 of the cooler 6.

The rotary evaporator 1 comprises a tempering vessel 10 which is realized here as a heating bath, into which the evaporation vessel 5 immerses in regions. In order to be able to position the evaporation vessel 5 with a part region in the tempering vessel 10 and in order to be able to interrupt the evaporating process by removing the evaporation vessel 5 out of the tempering vessel 10 where required, the glass assembly 4 and with it the evaporation vessel 5 is held on the guide tower 3 so as to be movable.

A heated volume of water or of oil is situated in the tempering vessel 10 which is realized here as a heating bath. The evaporation vessel 5, which includes the solution to be evaporated in its piston-shaped interior, rotates in the heated volume of water or oil of the tempering vessel 10. This solution is distributed onto the heated vessel inside walls of the rotating evaporation vessel 5 as a thin liquid film which is able to evaporate easily there. As a result of the rotation of the evaporation vessel 5, a delay in boiling is also avoided and in conjunction with the heating bath 10, which is situated in the tempering vessel 10, a homogeneous temperature distribution is obtained in the medium to be evaporated. The thorough mixing of the heating bath which is additionally brought about facilitates the regulating of the effective heating temperature in a considerable manner. To avoid high temperatures which are linked to risks to the user and can also bring about unwanted chemical reactions in the medium, the evaporating process is supported by creating a vacuum in the process chamber. The evaporator capacity is varied as a result of the temperature of the heating bath, the size of the evaporation vessel 5 and its rotational speed as well as the vacuum pressure set. On account of the general inertia of the temperatures of the medium and the process, the evaporation is controlled primarily by the pressure at constant temperatures. In order to be able to create a vacuum in the process chamber and in order to realize a coolant inflow and outflow 6, at least one hose connection and regularly several hose connections 11, 12, 13, which are connected to a vacuum pump or to the coolant inflow and outflow by means of in each case a flexible hose line 14, 15, 16, are provided on the glass assembly of the rotary evaporator which also includes the evaporation vessel 5.

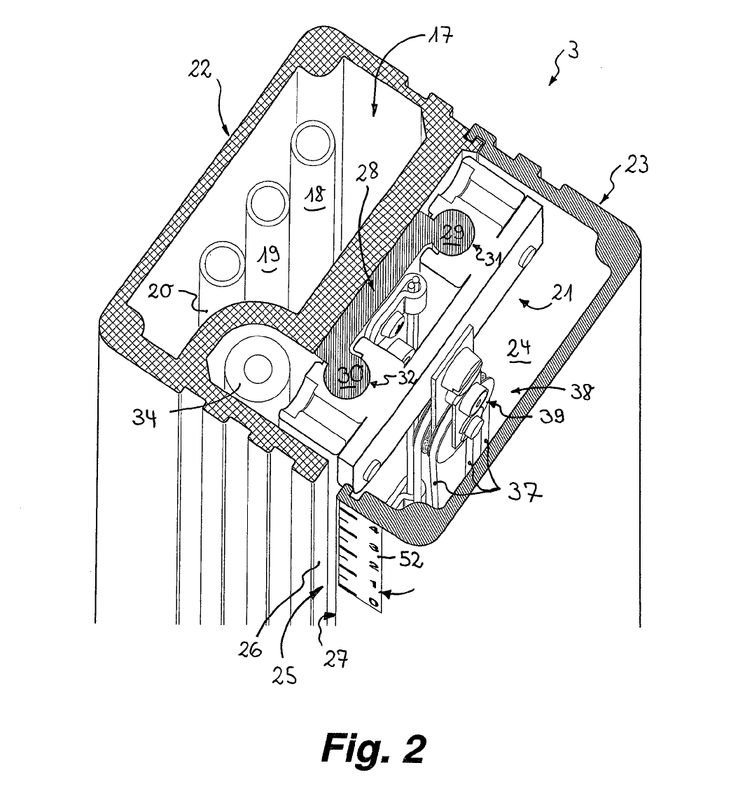

From the perspective cross sectional representation in FIG. 2 it is clear that the guide tower 3 comprises a channel 17 which is oriented in the longitudinal extension thereof, in which channel is provided a line portion of at least one fluid line which is connected to the glass assembly 4. The at least one fluid line ends in a hose connection which is associated therewith but is not shown any further here and is arranged on a bottom-side region of the rotary evaporator which is remote from the free end of the guide tower 3. As, consequently, a comparatively longer line portion of the at least one fluid line is guided in the channel 17 of the guide tower 3, the line portion of said fluid line which is laid freely outside the guide tower 3 and is realized here as hose line 14, 15 or 15 can be kept comparatively short. The risk of an inadvertent entanglement in said freely laid hose lines 14, 15, 16 is consequently minimized. As the at least one fluid line inside the guide tower 3 is guided downward, the connections of said fluid lines can be arranged on non-moving parts of the structure in the bottom-side region of the rotary evaporator 1 which is remote from the free end of the guide tower 3. In the case of the rotary evaporator shown here, the connections of the fluid lines are arranged in the base plate of the device stand 2.

In order to be able to guide the fluid line which leads to a vacuum pump as well as the fluid lines provided as coolant inflow and outflow and consequently several fluid lines in the channel 17 of the guide tower 3, it is provided that the line portions guided in the channel are realized as hose lines 18, 19, 20. In this case, the hose lines 18, 19 20 guided in the channel 17 and serving as a line portion are also connected at their line portion end remote from the bottom-side first hose connection 18, 19, 20 to a second hose connection (not shown here either) which is arranged on the free end region of the guide tower 3.

In order to be able to move the glass assembly 4 in a vertical direction, and in order to be able to lower the evaporation vessel 5 thereof into the tempering vessel 10 as well as also being able to lift it out of the tempering vessel 10 again, the glass assembly is held on a holder which is realized as a cradle or comprises a cradle 21. The cradle 21 is movable to the side of the guide tower 3. As the guide tower 3 consequently remains non-moving, the parts moved during the lifting and lowering of the evaporation vessel 5 can be minimized.

The guide tower 3 is formed from at least two profile portions 22, 23 which are preferably releasably connected together in a separating position which is oriented in the longitudinal extension of the guide tower 3. In this case, the guide tower 3 comprises a profile portion 22 which is realized as a hollow profile, the at least one hollow profile interior of which forms the channel 17 of the guide tower 3. The profile portions 22, 23 of the guide tower 3 define a cavity 24 which is realized open at a guide slot 25 which is oriented in the vertical direction. In the separating position the guide slot 25 is arranged between the profile portions 22, 23 and is defined by the adjacent narrow edges 26, 27 of said profile portions 22, 23. The cradle guide means 28 associated with the cradle 21 is provided in the cavity 24. Said cradle guide means 28 comprises two guide bars 29, 30, which are spaced apart from one another transversely with respect to the guide direction, are round in cross section and are encompassed by guide holes 31, 32 in the cradle 21.

The cradle 21 carries at least one connecting arm 33 which penetrates the guide slot 25 and is connected to the glass assembly 4. The cradle 21 is movable from a lifting position against the resetting force of at least one gas-filled spring 34 into a lowering position. A cable winch 35, which serves as a lifting drive and is held fixed in position with respect to the guide tower 3 on the structure of the rotary evaporator 1, is provided to move the cradle 21. The cable winch 35 comprises a cable 37 which can be wound onto a cable drum 35 and is guided on the cradle 21 in such a manner that by winding the cable 37 in and out and shortening and lengthening the cable portion protruding over the cable winch 35, the cradle 21 can be lifted by the resetting force or lowered against the resetting force. In the case of a power failure, the cable winch 35 releases the cable 37 wound thereon in such a manner that the resetting force is able to move the cradle 21 into the lifting position; as the cradle 21 is consequently automatically moved in the case of a power failure into its lifting position, in which the evaporation vessel 5 is situated at a spacing above the tempering vessel 10, the process running in the evaporation vessel 5 is cautiously interrupted and an uncontrolled overheating of the liquid to be evaporated is safely stopped.

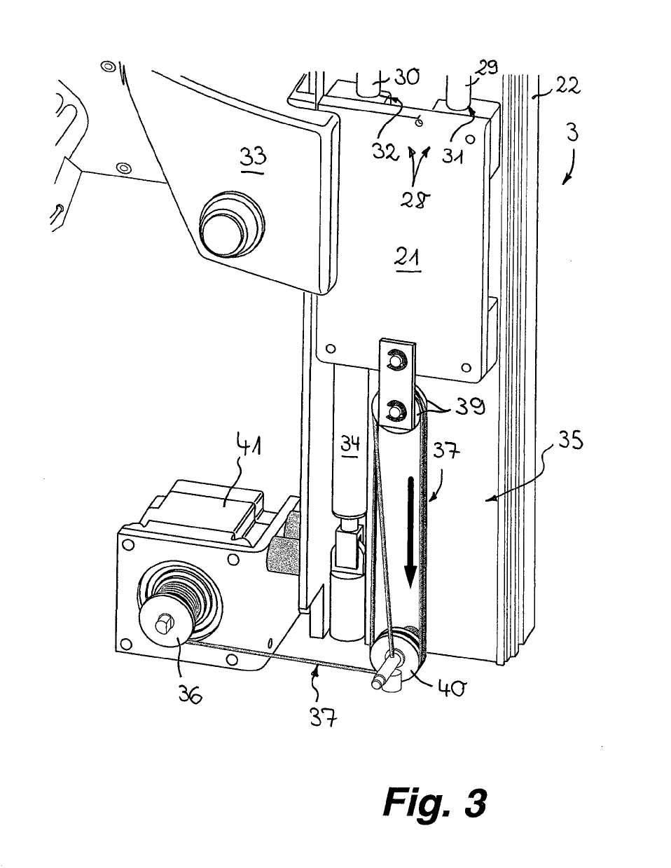

It can be seen in FIG. 3 that the cable 37 of the cable winch 35 is guided by means of a block and pulley 38, which block and pulley 38 has guide rollers 39, 40 which are spaced apart from one another. The block and pulley 38 comprises here a drive. The cable winch 35 has a stepping motor as an electric drive 41. As said stepping motor has a comparatively high torque, an additional gear unit is superfluous. As the drive shaft of the electric drive 41 with the motor switched off is almost torque-free, a safe emergency shut-down can also be guaranteed when there is an interruption in the power by the at least one gas-filled spring 34 serving as resetting force moving the cradle 21 into the upper lifting position. In this case, the at least one gas-filled spring 34 presses the cradle 21 in the upper lifting position against a top end stop. By means of an adjustable bottom stop, the depth of immersion of the evaporation vessel 5 in the heating bath of the tempering vessel 10 can be adjusted in dependence on the size and fill volume of the chosen evaporation vessel 5. By means of the stepping control of the electric drive 41, the cradle 21 can be moved in any desired lifting position. In this case, the top end stop serves as a reference for the stepping control of the electric drive 41.

The lifting mechanism which is formed by the cable winch 35, the electric drive 41 and the block and pulley 38 and serves at the start and end of the process for lowering and lifting out the evaporation vessel 5 and for fine adjustment of its depth of immersion in the heating bath, is distinguished by a comparatively long lifting travel which, when large evaporation vessels 5 are used, also ensures that they are completely lifted out of the tempering vessel 19. The speed of the electric drive 41 associated with the cable winch 35 is variable and comprises at least two speed stages. Whilst a high speed ensures a high traveling speed of the cradle 21 for rapid lowering or lifting out of the evaporation vessel 5, with a comparatively low speed a lower speed of the cradle 21 is obtained which is intended for fine adjustment of the depth of immersion of the evaporation vessel 5.

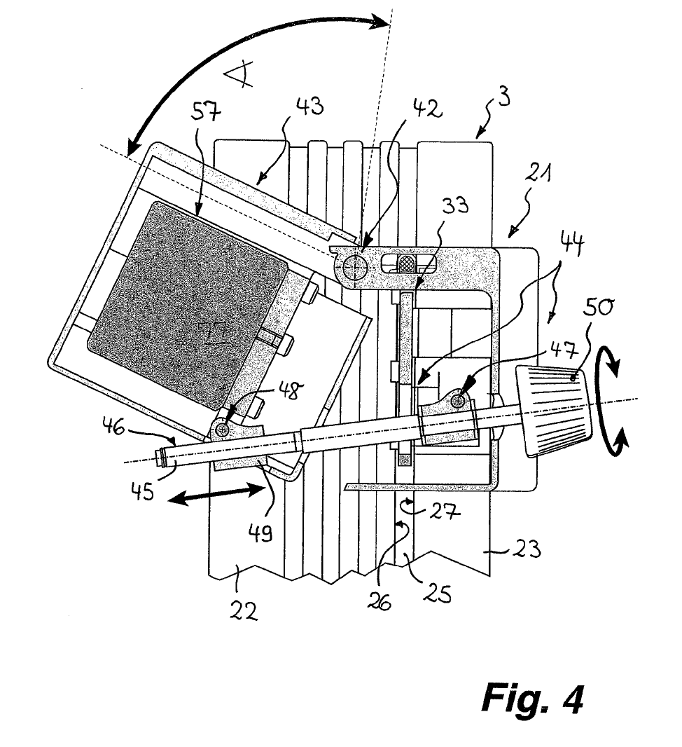

It can be seen from FIG. 4 that the cradle 21 here is a component part of a holder which serves for fastening the glass assembly 4 on the cradle 21. The glass assembly 4 shown in more detail in FIGS. 1 and 6 and in particular the evaporation vessel 5 thereof is held on the holder so as to be pivotable about a horizontal pivot axis 42. The holder comprises for this purpose a holding part which is realized here as a cradle 21, on which a carrying part 43 which is connectable to the evaporator device 5 is held so as to be pivotable about the horizontal pivot axis 42. A spindle drive 44 which has an adjusting spindle 45 with a self-locking spindle thread 46 is provided to adjust and secure the chosen pivot position. By rotating said adjusting spindle 45, the pivot angle between the holding part realized as a cradle 21 and the carrying part 43 of the holder can be modified and the pivot position of an evaporation vessel 5 fastened on the carrying part 43 can be varied. As the adjusting spindle 45 has a self-locking spindle thread 46, an additional and where applicable also inadvertently released safety device is not necessary. The spindle drive 44 allows the rotary evaporator 1 to be adapted to the different dimensions of the various evaporation vessels. The carrying part 43 of the holder carries the entire glass assembly 4, the center of gravity of which lies far off-center. Without the self-locking of the spindle thread 46, there would be the risk of the glass assembly, when releasing an alternative locking arrangement, falling un-braked into the bottom stop and breaking, with the glass assembly being evacuated, there also being the possibility of a danger of implosion.

It can be seen in FIG. 4 that the adjusting spindle 45 is held on the holding part realized as a cradle 21 and on the carrying part 43 so as to be pivotable preferably about a horizontal pivot axis 47, 48. The adjusting spindle 45, which is mounted on the holding part realized as a cradle 12 so as to be pivotable, but immovable in the axial direction, interacts with a spindle nut 49 which is held on the carrying part 43 so as to be pivotable about the pivot axis 48. On its one spindle end, the adjusting spindle 45 comprises an adjusting wheel 50 which serves as a handle. Adjusting speed and force expenditure can be optimized by means of the selection of the thread type of the adjusting thread 46 and of the pitch. As the adjusting thread 46 is realized in a self-locking manner, no further locking means is necessary which otherwise, during releasing, harbors the danger of the glass assembly inadvertently falling into the stop and breaking. The spindle drive 44, by way of which the tilt angle of the evaporation vessel 5 is able to be modified in a stepless manner, is also actuatable on the adjusting wheel 50 with only one hand. In conjunction with the variable depth of immersion of the evaporation vessel 5 into the tempering vessel 10 and the displaceability of the tempering vessel 10 described in more detail further below, the pivot mechanics shown in FIG. 4 allow a wide spectrum of variously large evaporation vessels 5 with variable fill volumes to be able to be used.

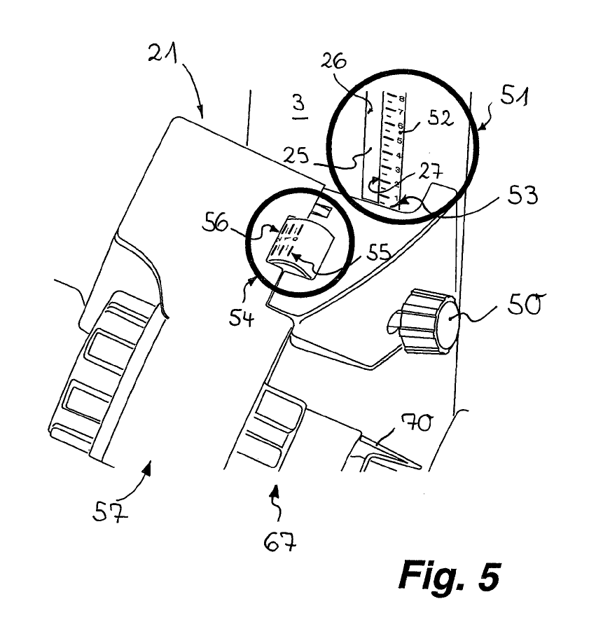

From a comparison of FIGS. 1 and 5 it is clear that the cradle 21, which is movable on the guide tower 3 in the vertical direction, is positionable by means of a graduation 51 which comprises a scale 52 which is provided on the outer circumference of the guide tower 3 and interacts with a pointer located on the cradle 21. Whilst the scale 52 is arranged on the outside wall edge region of the guide tower 3 adjacent the guide slot 24, the adjacent edge 53 of the cradle 21 serves as a pointer of the respective lifting height.

A further graduation 54, which is provided between the cradle 21 serving as a holding part and the carrying part 43, is provided for positioning the carrying part 43. This graduation 54 also comprises a scale 55 which is provided in this case on the cradle 21. This scale 55 has associated therewith a pointer which is arranged on the carrying part 43. The pointer, in this case, is formed by the adjacent edge 56 of the carrying part 43. The respective pivot angle of the glass assembly 4 which is held by means of the holder on the guide tower 3 can be measured by means of the graduation 54. The graduations 51, 54 facilitate the reproducibility of a test assembly in a considerable manner and promote the simple handling of the rotary evaporator 1 shown here.

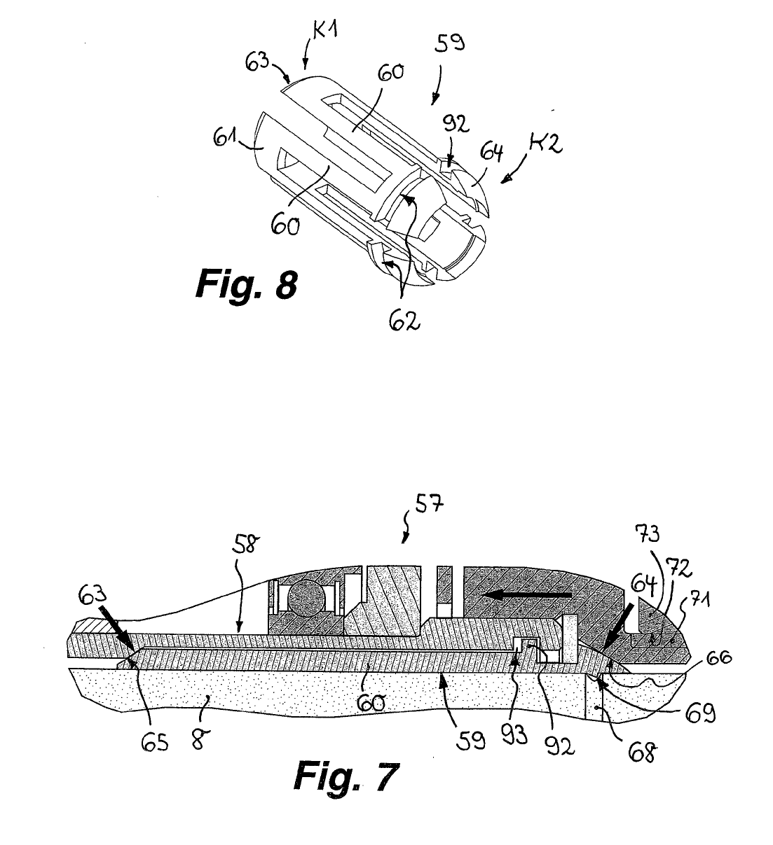

FIG. 6 shows a longitudinal section of a detail of the rotary evaporator 1 in the region of its rotary drive 57 provided on the carrying part 43 of the holder. The rotary drive 57 comprises a hub 58 which is rotationally drivable by means of an electric drive motor. The drive motor of the rotary drive 57 (not shown any further) is developed here as a brushless direct current motor with toothed belt drive. In order to be able to transmit the rotary movement of the hub 58 to the hollow glass shaft 8 carrying the evaporator vessel 5, the clamping insert 59 shown in more detail in FIGS. 7 and 8 is slipped onto said hollow glass shaft 8. The clamping insert 59 intended for clamping the hollow glass shaft 8 in the hub 58 has a sleeve-like basic form. For this purpose the clamping insert 59 comprises support bars 60 which are oriented in the longitudinal direction and are connected together by means of connecting webs 61, 62 which are oriented in the circumferential direction of the clamping insert 59. The connecting webs 61, 62 alternately connect the web ends of adjacent supporting webs 60 arranged on the one or on the other side of the clamping insert 59 in such a manner that each supporting web 60 is connected to its one adjacent supporting web by means of a connecting web 61 arranged on the one side of the clamping insert 59 and projecting into the one circumferential direction, whilst it is connected to the other adjacent supporting web by means of a connecting web 62 laid on the other side of the clamping insert and projecting into the opposite circumferential direction. In this case, the connecting webs 61, 62 provided on the opposite ends of the clamping insert 59 form clamping portions K1 and K2 of the clamping insert 59 which are spaced apart from one another. The connecting webs 61, 62 forming the clamping portions K1 and K2 are tapered toward the free ends of the clamping insert 59 in such a manner that the clamping portions K1 and K2 in each case carry at least one clamping incline 63, 64 which are beveled in relation to the longitudinal axis of the clamping insert 59 and which interact with counter inclines 65 or 66 of the rotary drive 1 associated with them in such a manner that the clamping portions K1 and K2 are pressed against the hollow glass shaft 8 as a result of axial pressurization of the clamping insert 59. As the clamping insert 59 has a loop-shaped or meander-shaped outer contour as a result of the supporting webs 60 and the connecting webs 61, 62 provided alternately on the opposite end regions of the supporting webs 60 and as said outer contour of the clamping insert 59, where required, can be widened in circumference in a simple manner, the clamping insert 59 is able to be comfortably positioned on the hollow glass shaft 8.

From FIG. 6 and the longitudinal section of the detail in FIG. 7 which shows the region in FIG. 6 marked by VII, it is clear that the clamping insert 59 is insertable from the side of the hub 58 facing the evaporation vessel 5 into said hub as far as up to a ring shoulder realized as a counter incline 65 on the inside circumference of the hub 58, and that for the axial pressurization of the clamping insert 59 a clamping screw ring 67 can be releasably screwed onto the hub 58, said clamping screw ring acting upon the clamping portion K2 of the clamping insert 59 protruding over the hub 58 with a counter incline 66 which is provided on the inside circumference of the clamping screw ring 67.

As the clamping insert 59 has a loop-shaped or meander-shaped outer contour as a result of the supporting webs 60 and the connecting webs 61, 62 provided alternately on the opposite end regions of the clamping insert 59 and as said outer contour of the clamping insert 59 when required can be widened in circumference in a simple manner, the clamping insert 59 is able to be positioned comfortably on the hollow glass shaft 8. The flexibility of the clamping insert 59 is achieved as a result of the axially extending narrow supporting webs 60 and the connecting webs 61, 41 connecting them. In the regions of the force transmission, namely in the clamping portions K1 and K2, the clamping portion 59 is designed in contrast with a large area in order to obtain plane clamping of the hollow glass shaft 8 serving as the vapor feed-through. The friction generated fixes the hollow glass shaft 8 in a play-free manner in the hub 58 of the rotary drive 57. A circumferential nose 92, which is realized here as an (interrupted) annular flange, engages in an annular groove 93 on the inside circumference of the hub 58 and secures the clamping insert 59 axially in the hub 58, is provided on the outside circumference of the clamping insert 59. When the hollow glass shaft 8 is disassembled, the clamping insert 59 consequently remains in the hub 57 and the clamping screw ring 67 is simply released and does not have to be removed in order to remove the hollow glass shaft 8 out of the hub 58 of the rotary drive 57.

It can be seen in FIGS. 6 and 7 that the hollow glass shaft 8 carries on its outside circumference an indentation 68 which is realized as an annular groove and has associated therewith an elevation 69, which is realized as an annular bead, on the inside circumference of the clamping insert 59. As the elevation 69 provided on the clamping insert 59 is arranged in the part region of the clamping insert 59 protruding over the hub 58 and in particular on the inside circumference of the clamping portion K2 protruding over the hub 58, the hollow glass shaft 8 can also still be inserted subsequently into the clamping insert 59 located in the hub 58 or removed from it when, for example, an exchange of the evaporation vessel 5 also requires a change in the hollow glass shaft 8.

It is clear is FIG. 6 that the hollow glass shaft 8 serving as a vapor feed-through is pushed through the hub 58 of the rotary drive 57 and is clamped in the hub 58 by means of the clamping insert 59, which is situated between the hub 58 and the hollow glass shaft 8, such that a rotation of the hub 58 of the rotary drive 57 about a longitudinal axis of the hub 58 leads to a corresponding rotation of the clamping insert 59, of the hollow glass shaft 8 and of the evaporation vessel 5 which is non-rotatable connected to the hollow glass shaft 8. The hub 58, the clamping insert 59 and the hollow glass shaft 8 are arranged concentrically with respect to one another. The non-rotatable connection between the hollow glass shaft 8 and the evaporation vessel 5 is ensured by a ground-in connection which is preferably realized as a taper-ground joint where the hollow glass shaft 8 engages in a ground-in sleeve which is realized on a vessel neck of the evaporation vessel 5 by way of its side facing the evaporation vessel 5 on which a ground-in core 94 is realized. An additional ground-in clamp 70 (cf. FIG. 1) can be provided to secure the ground-in connection between the hollow glass shaft 8 and the evaporation vessel 5.

It can be seen in FIG. 6 that the clamping screw ring 67 carries a thread 71, which interacts with a counter thread 72 on a forcing screw ring 73. When the forcing screw ring 73 is released from the clamping screw ring 67, the forcing screw ring 73 presses onto the evaporation vessel 5 and onto the vessel neck thereof in such a manner that the clamping or ground-in connection between the evaporation vessel 5 and the hollow glass shaft 8 carrying the evaporation vessel 5 is released.

The hollow glass shaft 8 which is realized as a vapor feed-through reaches by way of its shaft end remote from the evaporation vessel 5 into the connection opening 74 of the connecting piece 9 leading to the cooler 6 and is sealed in relation to said connecting piece 9 with a bearing ring seal which is shown in more detail in FIGS. 6, 9 and 10. This bearing ring seal is formed by a sealing ring 76 which is clamped between the connecting piece 9 and a drive housing 77 of the rotary drive 57 and abuts sealingly against the rotating hollow glass shaft 8. The sealing ring 76 is realized as a ring disk, the outer ring zone 78 of which serves as a clamping edge. The ring disk comprises a ring zone 79 which is bent over in the longitudinal extension of the hollow glass shaft 8 so that the sealing ring 76 abuts sealingly by way of a part region T of the ring disk which is oriented in the longitudinal direction of the hollow glass shaft 6. In this case, the part region T of the ring disk which is oriented in the longitudinal direction of the hollow glass shaft 8 abuts in an elastic manner against the hollow glass shaft 8 such that permanent sealing which is always constantly good is ensured in said region. The sealing ring 76 is realized in one piece and is producible with low expenditure as a material compound. In this case, a Teflon compound is preferred which excels as a result of a low coefficient of friction and reduced wear.

The sealing ring 76, which is developed in a j-shaped or u-shaped manner in longitudinal section and the inside edge 95 of which defining the ring opening can be curved outward in a direction remote from the hollow glass shaft 8, comprises at its clamping edge at least one annular groove 80, with which a complementary annular bead 81 on the adjacent end edge of the drive housing 77 can be associated.

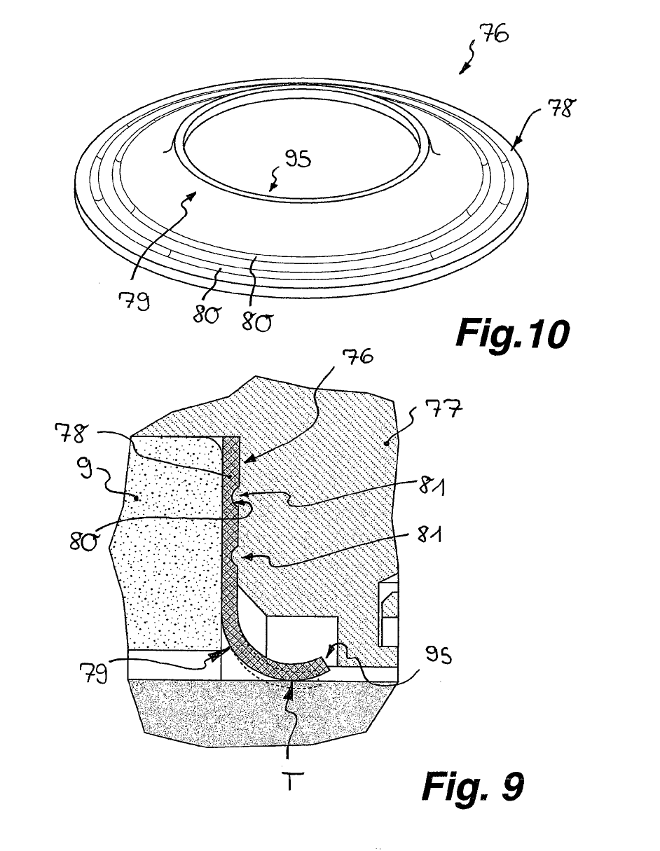

A comparison of the inner ring zone 79 shown in FIG. 9 on the one hand in continuous lines and on the other hand in broken lines indicates that said ring zone 79 lies pre-stressed in the direction toward the hollow glass shaft 8 in such a manner that as a result, in the case of wear, the sealing ring 76 abutting against the hollow glass shaft 8 is automatically readjusted.

The clamping insert 59 is preferably realized as a plastics material part and in particular as an injection molded plastics material part. As in the region of the inner ring zones 79 of the sealing ring 76 the glass of the hollow glass shaft 9, the clamping insert 59 in particular produced from plastics material and the preferably metal hub 58 of the rotary drive 57 abut against one another under pressing pressure, such a material choice of said individual parts 9, 59, 58 provides the ideal combination between softness, rigidity and frictional engagement for said individual parts which rotate with one another.

The rotary drive 57 has associated therewith a motor control which is not shown any further and preferably has stepless speed adjustment in particular with the possibility to reverse the direction of rotation. To avoid solid residues adhering to the inside wall of the vessel, in particular during a drying process, an operating mode which provides periodic reversal of the direction of rotation can be sensible. In order to bring about automatic cutout of the rotary evaporator 1 if the rotary movement is blocked, monitoring of the motor current is provided. A smooth startup of the rotary drive 57 is provided at the beginning of the rotary movement, to which end a corresponding start characteristic which can provide, for example, a limit to the motor current, is filed in the motor control of said rotary drive.

The tempering vessel 10 serves for tempering the liquid bath which is situated in the tempering vessel 10 and in particular for the controlled supply of heat into the evaporation vessel 5. The tempering vessel 10 comprises to this end an electric tempering device and in particular an electric heating device. The oil or water used as tempering liquid is circulated as a result the rotation of the evaporation vessel 5 in such a manner that a homogeneous temperature distribution is ensured. The inertia of the bath temperature stabilizes the heating temperature when boiling commences in the evaporation vessel 5 (evaporative coldness).

In order to be able to fill and empty the tempering vessel 10 in a simple manner, the tempering vessel 10 is placed in a removable manner onto the device stand 2 of the rotary evaporator. The device stand 2 is sufficiently stable in order to exclude the rotary evaporator 1 falling over even when the tempering vessel 10 has been removed. At least one positioning projection, which interacts with an associated positioning projection on the tempering vessel 10 or on the device stand 2, is provided on the device stand 2 or on the tempering vessel 10. The rotary evaporator 1 preferably comprises two such positioning projections, which interact in each case with a positioning indentation and protrude in a journal-like manner, the one of which is intended for electrically contacting the tempering device provided in the tempering vessel 10 by way of an electrical connection on the device stand and the other positioning projection of which is intended for contacting the signal connection between the rotary evaporator 1 and a temperature sensor incorporated into the tempering vessel 10.

An electric coupling, which is intended for electrically contacting the tempering device provided in the tempering vessel by way of an electrical connection on the device stand, is arranged in the region of the positioning projection and the positioning indentation, which are movable in an approximately axially-parallel manner with respect to the rotational axis of the rotary drive 57. In order to vary the position of the evaporation vessel 5 in relation to the device stand 2 and in order to be able to use variously large evaporation vessels 5 in the rotary evaporator 1, the at least one positioning projection provided on the device stand 2 or the positioning indentation thereon is held so as to be movable by means of a sliding guide which is not shown here in any more detail. This sliding guide has at least two sliding parts which interlock in a telescopic manner. One sliding part of which is held in an immobile manner on the device stand 2 and another sliding part of which carries the at least one positioning projection or the at least one positioning indentation.

It is clear from FIG. 1 that the tempering vessel 10 comprises an approximately triangular basic form at least in its clear inner cross section and preferably also in its outer cross section. In order to counteract the tempering liquid located in the tempering vessel 10 sloshing about in operation and when the tempering vessel 10 is being transported, the tempering vessel 10 has vertically oriented, that means extensively perpendicular vessel inside walls 88 except in the region of a spout 87. The spout 87 is provided in the extension of the apex line 75 of the triangular basic form, the apex line 75 being oriented in the direction facing the evaporation vessel 5. Ergonomic recessed grips, by way of which the tempering vessel can be comfortably gripped, are provided on the outside circumference of the tempering vessel 10. A scale preferably provided on at least one of the inside walls 88 of the vessel indicates the fill level of the tempering liquid. As the tempering vessel 10 is displaceable along the rotational axis, a large spectrum of evaporation vessels can be used. Even larger evaporation vessels 5 can be immersed in the tempering vessel 10 because said vessel is developed in a correspondingly deep manner. A transparent cover 89 can be placed on the tempering vessel 10. The cover 89 comprises at least one first cover part 90 which can be placed on the top narrow edge of the tempering vessel 10, on which at least one second cover part 91 is held so as to be able to be pivoted or folded up. As the evaporation vessel 5, which in the majority of cases is under vacuum during operation, is produced from glass for the purposes of an improved heat transfer in the liquid bath and as preferably the remaining components of the glass assembly 4 only consist of break-proof glass or glass coated as a shatterproof protection, the cover 89 serves as shatterproof protection.

The tempering vessel 10 comprises a fill level sensor which is connected in a control manner to a dosing pump which is connected to a tempering liquid supply. The fill level sensor is a component part of a fill level monitoring means which, when a minimum tempering liquid is fallen below, brings about an emergency cutoff. In addition to or instead of this, the fill level sensor can also be a component part of a fill level regulating means which is intended for compensating evaporation losses.

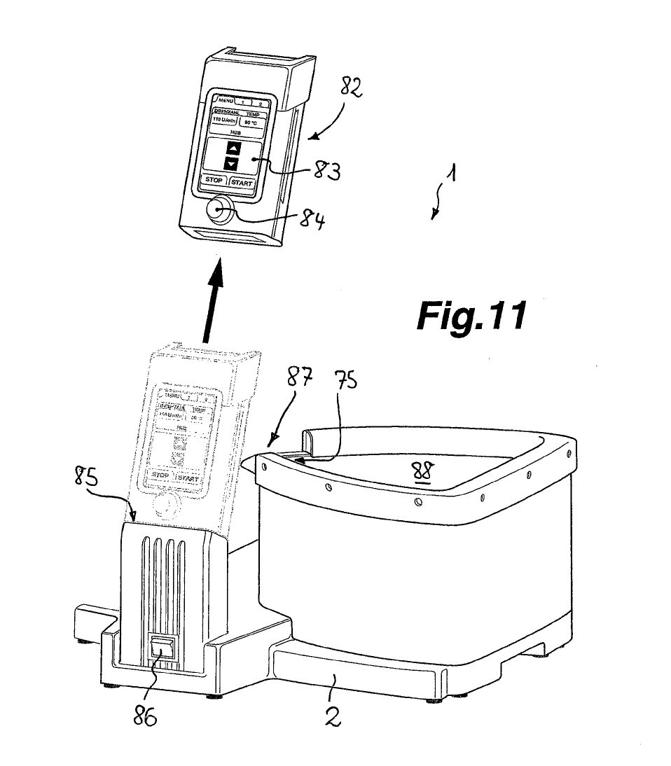

From a comparison of FIGS. 1 and 11 it is clear that the operation of the rotary evaporator 1 is effected by means of a central control unit 82 which enables direct access to all the technical functionalities and consequently, among other thing, also to the rotary drive 57, the lifting drive and the tempering device provided in the tempering vessel 10.

In order also to be able to operate the rotary evaporator 1 when it is situated in a protected manner for example in a vent, the control unit 82 is realized as a remote control unit which is detachable from the rotary evaporator 1 and is preferably wireless. A data transmission interface which, for example, can be realized as a USB interface, allows for the process control and/or the documentation of the process parameters on an external data processing system and in particular on the PC. The remote control unit 82 which is usable as a wireless remote control comprises a display 83 which is preferably developed as a touch screen with intuitive control elements which are adapted to the operating mode. A control button 84, which is realized here as a push-and-turn button and can be utilized, for example, to input numerical values, is provided on the control unit 82.

A console or compartment 85 for the control unit 82, which ensures an optimum control height of the control elements and of the display 83 when the control unit 82 is deposited therein and which, for this purpose, protrudes above the device stand 2, is provided on the rotary evaporator 1. As an option, the rotary evaporator according to the invention can either be operated directly with the remote control unit 82 located on the console 85 or also actuated by means of the remote control unit 82 at a distance. A mains switch 86, which is also usable as an emergency cutoff, is arranged so as to be easily reachable on the front side of the rotary evaporator 1.

The display 83 which is developed as a touch screen serves, for example, to indicate the actual temperature in the liquid bath, the required temperature of the tempering device incorporated into the tempering vessel 10, the speed of the rotary drive or to indicate comparable process parameters. In order to select the control functions visible on the display 83 and/or to be able to modify the process parameters, the control button 84 can also be used in addition to or instead of this. In order to develop the operation of the control device, which is preferably situated in the rotary evaporator 1 and can also include the motor control means for the rotary drive 57, in as simple a manner as possible, individual functions of the control device are arranged in a menu structure which can be shown on the display 83, the scrolling through the individual menus being effected by means of the control button 84 and/or the display 83 which is realized, where applicable, as a touch screen.

The compartment or console 85, which projects on the rotary evaporator 1 above the device stand 4 thereof, is provided for the supporting or depositing of the remote control unit 82. The compartment or console 85 has at least one contact system which is releasably connectable to the control unit 82 and comprises for supplying power to the charging system for the batteries located in the control unit 82 and preferably also to the conductor-based control connection between the at least one control element 83, 84 of the control unit 82 and the control device by cutting off the wireless control connection. If the control unit 82 rests on the compartment or console 85, the wireless control connection is temporarily adjusted for the benefit of a conductor-based control connection between the at least one control element 83, 84 provided on the control unit 82 and the control device.

The control device of the rotary evaporator 1 also comprises an emergency cutout function, the triggering of which interrupts the power supply to the tempering device in the tempering vessel 10 and triggers the movement upward of the glass assembly 4 which is held so as to be movable on the guide tower 3. In this case, the emergency cutout function stored in the control device can be triggered, for example, manually at a special emergency cutout switch on the control unit 82 or at the mains switch 86 of the rotary evaporator 1 or can also be triggered automatically when the control unit 82 is no longer supplied with power or the wireless control connection between the remote control unit 82 and the rotary evaporator 1 is interrupted. As the power supply to the tempering device in the tempering vessel 10 is interrupted, further uncontrolled heating up of the test installation is not to be feared. As the evaporation vessel 5 is also moved out of the operating position located in the liquid bath into the initial position provided outside the tempering vessel 10, the liquid situated in the evaporation vessel 10 cannot be unintentionally heated up by the residual heat situated in the liquid bath.

For example, the actual temperature of the tempering liquid located in the tempering vessel 10 can also be read-off on the display 83 of the control unit 82. The necessary required temperature of the tempering liquid located in the tempering vessel 10 can be predefined by means of the display 83 realized as a touch screen and/or the control button 84. In the same way, a change in the rotational direction of the rotary drive 57 preferably in selectable time intervals can also be predefined in the control device. Finally it can also be predefined by means of the control unit 82 how far the evaporation vessel 5 of the glass assembly 4 is to be moved downward on the guide tower 3, a fine adjustment of the depth of immersion of the evaporation vessel 5 in the tempering vessel 10 can also be possible by rotating the control button 84.

As a result of heating up the evaporation vessel 5 in the liquid bath of the tempering vessel 10, the solution located in the evaporation vessel 5 evaporates and the vapor flows through the hollow glass shaft 8 which serves as a vapor feed-through into the connecting piece which leads to the cooler 6. The vapor can condense in the cooler 6 and flow off into the collecting vessel 7. A separation of material constituent parts is achieved as a result of the boiling points thereof differing such that in the case of a predefined temperature certain materials can evaporate, whilst other materials initially still remain in the evaporation vessel. As a result of applying a vacuum to the glass assembly 4, the boiling temperatures can be lowered, as a result of which solvents which boil at higher temperatures are able to be evaporated at a lower temperature than would normally be the case. In the glass assembly 4 which is under vacuum, substances which are temperature-sensitive can also be distilled. As a result of working at a lower boiling temperature, destruction of such temperature-sensitive substances can be prevented. The sealing ring 76, which serves as a bearing ring seal, in this case seals the rotating hollow glass shaft 8 against atmospheric pressure and thus ensures that the vacuum in the interior of the glass assembly 4 is maintained. As the inside diameter of the sealing ring 76 is somewhat smaller than the diameter of the hollow glass shaft 8 in this region, the sealing ring 76 is pre-stressed and this is increased by the pressure difference present at the sealing ring. When the sealing ring 76 becomes worn as a result of friction, the bearing ring seal readjusts automatically as a result of the prestress of the sealing ring 76. The annular beads 81 provided on the drive housing 77 press the sealing ring in a ring-shaped manner against the connecting piece 9 in such a manner that the magnification of the surface pressure along said two closed lines additionally provides for an optimum seal.

The evaporation process is terminated by a controlled shut-down which is effected independently of the power supply by lifting the evaporation vessel 5 out of the tempering vessel 10, by stopping the rotation of the rotary drive 57, by suddenly eliminating the vacuum created in the glass assembly 4, or by shutting down the cooling of the cooler 6, the cooler 6 having associated therewith an interface for an on/off valve for this purpose. A shut-down of the rotary evaporator 1 and consequently termination of the evaporating process can be triggered by a user by achieving a predefined process parameter (process end), a process error or by a power failure.

### LIST OF REFERENCES

| | |
|---|---|
| Rotary evaporator | 1 |
| Devices stand | 2 |
| Guide tower | 3 |
| Glass assembly | 4 |
| Evaporation vessel | 5 |
| Cooler | 6 |
| Collecting vessel | 7 |
| Hollow glass shaft | 8 |
| Connecting piece (of the cooler) | 9 |
| Tempering vessel | 10 |
| Hose connection (on the glass assembly) | 11 |
| Hose connection (on the glass assembly) | 12 |
| Hose connection (on the glass assembly) | 13 |
| Hose line (laid freely) | 14 |
| Hose line (laid freely) | 15 |
| Hose line (laid freely) | 16 |
| Channel | 17 |
| Hose line (in the guide tower) | 18 |
| Hose line (in the guide tower) | 19 |
| Hose line (in the guide tower) | 20 |
| Cradle | 21 |
| Profile portion (hollow profile) | 22 |
| Profile portion | 23 |
| Cavity (between the profile portions) | 24 |
| Guide slot | 25 |
| Narrow edge (of the profile portion 22) | 26 |
| Narrow edge (of the profile portion 23) | 27 |
| Cradle guide | 28 |
| Guide bar (of the cradle guide 28) | 29 |
| Guide bar (of the cradle guide 28) | 30 |
| Guide hole (in the cradle 21) | 31 |
| Guide hole (in the cradle 21) | 32 |
| Connecting arm | 33 |
| Gas-filled spring | 34 |
| Cable winch | 35 |
| Cable drum | 36 |
| Cable | 37 |
| Block and pulley | 38 |
| Guide rollers (of the block and pulley) | 39 |
| Guide rollers (of the block and pulley) | 40 |
| Electric drive (of the cable winch) | 41 |
| Pivot axis (of the holder) | 42 |
| Carrying part (of the holder) | 43 |
| Spindle drive | 44 |
| Adjusting spindle | 45 |
| Spindle thread | 46 |
| Pivot axis (of the adjusting spindle on the holding part) | 47 |
| Pivot axis (of the spindle nut) | 48 |
| Spindle nut | 49 |
| Adjusting wheel | 50 |
| Graduation (for lift height) | 51 |
| Scale (of the graduation 51) | 52 |
| Edge (of the cradle 21 as indication of the lift height) | 53 |
| Graduation (for the pivot angle) | 54 |
| Scale (of the graduation 54) | 55 |
| Edge (on the carrying part 43 as indication of graduation 54) | 56 |
| Rotary drive | 57 |
| Hub | 58 |
| Clamping insert | 59 |
| Supporting webs | 60 |
| Connecting webs (left) | 61 |
| Connecting webs (right) | 62 |
| Clamping incline (left) | 63 |
| Clamping incline (right) | 64 |
| Counter incline (in the hub) | 65 |
| Counter incline (in the clamping screw ring) | 66 |
| Clamping screw ring | 67 |
| Indentation | 68 |
| Elevation | 69 |
| Ground-in clamp | 70 |
| Thread (on clamping screw ring 67) | 71 |
| Counter thread (on forcing screw ring) | 72 |
| Forcing screw ring | 73 |
| Connection opening (of the connecting piece) | 74 |
| Apex line | 75 |
| Sealing ring | 76 |
| Drive housing | 77 |
| Outer ring zone (of the sealing ring) | 78 |
| Bent-over ring zone (of the sealing ring) | 79 |
| Annular groove (on the sealing ring) | 80 |
| Annular bead (on end edge of the drive housing) | 81 |
| (Remote) control unit | 82 |
| Display | 83 |
| Control button | 84 |
| Compartment or console (for control unit) | 85 |
| Mains switch | 86 |
| Spout | 87 |
| Vessel inside walls of the tempering vessel | 88 |
| Cover | 89 |
| Fixed cover part | 90 |
| Foldable cover part | 91 |
| Nose | 92 |
| Annular groove | 93 |
| Ground-in core | 94 |
| Inside edge | 95 |
| Clamping portion (left) | K1 |
| Clamping portion (right) | K2 |
| Part region (of the sealing ring) | T |

1. A rotary evaporator (1), comprising a rotary drive (57) with a hub (58) and a clamping insert (59) with a sleeve-shaped basic form for clamping a vapor feedthrough formed as a hollow glass shaft (8) in the hub (58) of the rotary drive (57), the clamping insert (59) comprises two clamping portions (K1, K2), which are spaced apart from one another in a longitudinal direction and carry in each case at least one clamping inclination (63, 64) beveled in relation to the longituidnal axis of the clamping insert (59), said clamping inclinations interacting with counter inclinations (65, 66) of the rotary drive (57) associated therewith in such a manner that the clamping portions (K1, K2) are pressed against the hollow glass shaft (8) as a result of axial pressurization of the clamping insert (59), the clamping insert (59) further comprises supporting webs (60) which are oriented in the longitudinal direction thereof and are connected together by connecting webs (61, 62) oriented in a circumferential direction of the clamping insert (59), and the supporting webs (60) and the connecting webs (61, 62) are connected in such a manner to form the sleeve-shaped basic form of the clamping insert (59), the connecting webs (61, 62) alternately connect web end regions of adjacent supporting webs (60) which are arranged on the one or on the other side of the clamping insert (59), and the clamping portions (K1, K2) which are spaced apart from one another are formed by the connecting webs (61, 62) which are provided on opposite ends of the clamping insert (59) and carry the clamping inclinations (63, 64).

2. The rotary evaporator as claimed in claim 1, wherein the clamping inclinations (63, 64) which are carried by the connecting webs (61, 62) provided on the opposite ends of the clamping insert (59) have in each case an outside cross section which tapers to the adjacent end of the clamping insert (59).

3. The rotary evaporator as claimed in claim 1, wherein the clamping insert (59) is insertable from a side of the hub (58) which faces an evaporation vessel (5) into said hub as far as up to a ring shoulder which is formed as one of the counter inclinations (65) and a clamping screw ring (67) is detachably screwed onto the hub (58) for the axial pressurization of the clamping insert (59) and said clamping screw ring acts upon the clamping portion (K2) of the clamping insert (59) which protrudes over the hub (58) by way of the counter inclination (66) which is provided on an inside circumference of the clamping screw ring (67).

4. The rotary evaporator as claimed in claim 3, wherein the clamping screw ring (67) carries a thread (71) which interacts with a counter thread (72) on a forcing screw ring (73) and when the forcing screw ring (73) is unscrewed from the clamping screw ring (67), the forcing screw ring (73) acts upon the evaporation vessel (5) in such a manner that a clamping or ground-in connection between said evaporation vessel (5) and the hollow glass shaft (8) which carries the evaporation vessel (5) is releasable.

5. The rotary evaporator as claimed in claim 1, wherein the hollow glass shaft (8) carries on an outside circumference at least one indentation (68) or elevation with which is associated an elevation (69) or indentation on an inside circumference of the clamping insert (59).

6. The rotary evaporator as claimed in claim 5, wherein the at least one indentation provided on the hollow glass shaft (8) or on the clamping insert (59) is realized as an annular groove and the associated elevation is realized as an annular bead.

7. The rotary evaporator as claimed in claim 5, wherein the at least one indentation or elevation provided on the clamping insert (59) is arranged in a part region of the clamping insert (59) which protrudes above the hub (58).

8. The rotary evaporator as claimed in claim 1, wherein the vapor feedthrough which is realized as the hollow glass shaft (8) caries an evaporation vessel (5) on one first shaft end and protrudes by way of a second shaft end into a connecting opening (74) of a cooler (6) which is defined by a connecting piece (75), a sealing ring (76) abuts against the hollow glass shaft (8) in a sealing manner, said sealing ring being clamped between the connecting piece (75) and a drive housing (77) and being formed as an annular disk, an outer ring zone (78) of which is provided as a clamping edge, the annular disk has an inner ring zone (79) which is bent over or angled in the longitudinal direction of the hollow glass shaft (8), and the sealing ring (76) abuts sealingly in an elastic manner against the hollow glass shaft (8) by way of a part region (T) of the annular disk which is oriented in the longitudinal direction of the hollow glass shaft (8).

9. The rotary evaporator as claimed in claim 8, wherein the sealing ring (76) is realized in one piece.

10. The rotary evaporator as claimed in claim 8, wherein the sealing ring (76) is produced as a Teflon compound.

11. The rotary evaporator as claimed in claim 8, wherein at least one annular groove or one annular bead (81) is provided at at least one of the connecting piece (75) or at the drive housing (77) and the at least one annular groove or the at least one annular bead has associated therewith a complementary annular groove or an annular bead on the clamping edge of the sealing ring.

12. The rotary evaporator as claimed in claim 8, wherein the sealing ring (76) is approximately U-shaped, L-shaped or j-shaped in longitudinal section.

13. The rotary evaporator as claimed in claim 8, wherein the inside edge region and an edge region (95) defining the annular opening of the sealing ring (76) is curved or angled in a direction facing away from the hollow glass shaft.
